(19) United States
(12) Patent Application Publication
(10) Pub. No.: US 2007/0122660 A1
(43) Pub. Date: May 31, 2007

(54) Magnetic recording media with manganese-containing underlayer

(75) Inventors: Weilu Xu, San Jose, CA (US); Li-Lien Lee, San Jose, CA (US); Charles C. Chen, Milpitas, CA (US); Shanghsien A. Rou, Fremont, CA (US); Kuo-Hsing S. Hwang, San Jose, CA (US)

Correspondence Address: SEAGATE TECHNOLOGY LLC;c/o MCDERMOTT WILL & EMERY LLP, 600 13TH STREET, NW, WASHINGTON, DC, 20005-3096, US

(73) Assignee: SEAGATE TECHNOLOGY LLC

(21) Appl. No.: 11/287,240

(22) Filed: Nov. 28, 2005

(51) Int. Cl. G11B 5/66

(52) U.S. Cl. 428/831

(57) ABSTRACT

A thin film magnetic recording medium with enhanced signal-to-noise ratio (SNR) comprises a non-magnetic substrate having a surface; and a layer stack atop the substrate surface, comprising at least one magnetic recording layer and a plurality of layers beneath the at least one magnetic recording layer, including: a first underlayer proximal the substrate surface; a second, grain size refinement underlayer in overlying contact with the first underlayer; a third, in-plane growth orientation underlayer in overlying contact with the second underlayer; and a magnetic stabilization layer in overlying contact with the third underlayer, wherein the third underlayer comprises manganese (Mn).

### FIELD OF THE INVENTION

The present invention relates to magnetic recording media, such as thin film magnetic recording disks. The present invention has particular applicability to high a real density longitudinal magnetic recording media exhibiting low noise and enhanced magnetic performance.

### BACKGROUND OF THE INVENTION

Magnetic recording media are extensively employed in the computer industry and can be locally magnetized by a write transducer or write head to record and store information. The write transducer creates a highly concentrated magnetic field which alternates direction based upon bits of the information being stored. When the local magnetic field produced by the write transducer is greater than the coercivity of the recording medium, grains of the recording medium at that location are magnetized. The grains retain their magnetization after the magnetic field produced by the write transducer is removed. The direction of the magnetization matches the direction of the applied magnetic field. The magnetization of the recording medium can subsequently produce an electrical response to a read sensor, allowing the stored information to be read.

There is an ever increasing demand for magnetic recording media with higher storage capacity and lower noise. Efforts, therefore, have been made to reduce the space required to magnetically record bits of information while maintaining the integrity of the information. The space necessary to record information in magnetic recording media depends upon the size of transitions between oppositely magnetized areas. It is, therefore, desirable to produce magnetic recording media that will support the smallest transition size possible. However, the signal output from the transition must avoid excessive noise to reliably maintain the integrity of the stored information. Media noise is generally characterized as the sharpness of a signal on readback against the sharpness of a signal on writing and is generally expressed as signal-to-noise ratio (“SNR”) of the medium.

The increasing demands for higher a real recording density impose increasingly greater demands on thin film magnetic recording media in terms of coercivity (Hc), magnetic saturation (Ms), magnetic remanance (Mr), coercivity squareness (S*), SNR, and narrow track recording performance. It is extremely difficult to produce a magnetic recording medium satisfying such demanding requirements.

The linear recording density can be increased by increasing the Hc of the magnetic recording medium, and can be accomplished by decreasing the medium noise, as by maintaining very fine magnetically non-coupled grains. Medium noise in thin films is a dominant factor restricting increased recording density of high density magnetic hard disk drives, and is attributed primarily to inhomogeneous and large grain size and intergranular exchange coupling. Accordingly, in order to increase linear density, medium noise must be minimized by suitable microstructure control.

Longitudinal magnetic recording media containing cobalt (Co) or Co-based alloy magnetic films with a chromium (Cr) or Cr alloy underlayer deposited on a non-magnetic substrate have become the industry standard. For thin film longitudinal magnetic recording media, the desired crystallized structure of the Co and Co alloys is hexagonal close-packed (hcp) with uniaxial crystalline anisotropy and a magnetization easy direction along the c-axis is in the plane of the film. The better the in-plane c-axis crystallographic texture, the more suitable is the Co alloy thin film for use in longitudinal recording to achieve high remanance. For very small grain sizes coercivity increases with increased grain size. The large grains, however, result in greater noise. Accordingly, there is a need to achieve high coercivities without the increase in noise associated with large grains. In order to achieve low noise magnetic recording media, the Co alloy thin film should have uniform small grains with grain boundaries capable of magnetically isolating neighboring grains. This type of microstructural and crystallographic control is typically attempted by manipulating the deposition process, grooving the substrate surface and proper use of an underlayer.

If the uniformity of the grains in the underlayer structure is improved, the improvement in uniformity propagates to the grains in the overlying magnetic layer(s), thereby achieving high SNR. However, such improvement in uniformity must be effected without disturbing the crystallographic orientation of the magnetic grains. Unfortunately, this objective is not easily achieved. More specifically, gains in SNR of longitudinal magnetic recording media are mainly obtained by the following two improvements: (1) decreased inter-granular coupling of the magnetic grains by introduction of certain elements, e.g., Cr, Pt, Cu, Au, B, etc., into the magnetic layer(s); and (2) formation of more refined grains with increased size uniformity and crystal growth in an in-plane axis by introduction of certain elements, e.g., B, Mo, Nb, Ru, Ti, Ta, V, W, etc., into Cr-based underlayers.

U.S. Pat. No. 6,821,654, assigned to the assignee of the present application, discloses an about 0.6 dB increase in SNR of longitudinal magnetic recording media by means of another approach, i.e., replacing a CrW underlayer with a CrMoTa underlayer. Subsequent attempts at further improving (i.e., increasing) the SNR, etc., of longitudinal magnetic recording media have involved reduction in the amount of Co (a magnetic element) in the alloy(s) of the magnetic recording layer(s), e.g., by increasing the amount of Cr (a non-magnetic element) in the alloy(s), e.g., from about 22 at. % to about 26 at. %. However, the ability to reduce the amount of Co in the alloy(s) by increasing the amount of Cr is limited. For example, Co_{0.525}Cr_{0.26}Pt_{0.135}B_{0.06}Cu_{0.02}, i.e., with 26 at. % Cr, is a good alloy for use as a magnetic recording layer with low media noise (but with low coercivity). On the other hand, Co_{0.515}Cr_{0.27}Pt_{0.135}B_{0.06}Cu_{0.02}, i.e., with only 1 at. % more Cr, is non-magnetic, thereby limiting this avenue (or approach) for obtaining further increase in SNR of longitudinal media.

In view of the foregoing, there exists a continuing need for high a real density longitudinal magnetic recording media exhibiting even higher coercivity and SNR.

### SUMMARY OF THE INVENTION

An advantage of the present invention is improved thin film magnetic recording media affording high a real recording density with enhanced signal-to-noise ratios.

Additional advantages and other features of the present invention will be set forth in the description which follows and in part will become apparent to those having ordinary skill in the art upon examination of the following or may be learned from the practice of the present invention. The advantages of the present invention may be realized and obtained as particularly pointed out in the appended claims.

According to an aspect of the present invention, the foregoing and other advantages are obtained in part by a thin film magnetic recording medium with enhanced signal-to-noise ratio (“SNR”), comprising:
a non-magnetic substrate having a surface; and
a layer stack atop the substrate surface, the layer stack comprising at least one longitudinal magnetic recording layer and a plurality of layers beneath the at least one magnetic recording layer, the plurality of layers including:
i. a first underlayer proximal the substrate surface;
ii. a second, grain size refinement underlayer in overlying contact with the first underlayer;
iii. a third, in-plane growth orientation underlayer in overlying contact with the second underlayer; and
iv. a magnetic stabilization layer in overlying contact with the third underlayer, wherein:
the third underlayer comprises manganese (Mn).

According to embodiments of the present invention, the third underlayer comprises a CrMoMn alloy. Preferably, the CrMoMn alloy contains about 5 at. % Mn, from about 10 to about 20 at. % Mo, and is from about 15 to about 22 Å thick.

Embodiments of the present invention include those wherein the non-magnetic substrate comprises a metal or a metal alloy; the first underlayer is Cr; the second underlayer is a CrMoB alloy or a CrB material; the third underlayer is a CrMoMn alloy; and the magnetic stabilization layer is a CoCrTa alloy.

Further embodiments of the present invention include those wherein the non-magnetic substrate comprises a glass or a glass-ceramic material; the first underlayer is a CrTi alloy; the second underlayer is Cr; the third underlayer is a CrMoMn alloy; and the magnetic stabilization layer is a CoCrTa alloy.

In accordance with embodiments of the present invention, the plurality of layers further includes a non-magnetic spacer layer in overlying contact with the magnetic stabilization layer and a magnetic enhancement layer in overlying contact with the spacer layer; wherein the magnetic stabilization and enhancement layers are anti-ferromagnetically (“AFC” ) coupled across the spacer layer; and the at least one non-magnetic spacer layer comprises a material selected from the group consisting of ruthenium (Ru) and Ru-based alloys.

According to embodiments of the present invention, each of the magnetic stabilization and enhancement layers comprises a Co-based magnetic alloy.

According to embodiments of the present invention, the at least one magnetic recording layer comprises a plurality of magnetic layers in overlying contact, e.g., first and second magnetic recording layers, wherein the first magnetic recording layer is proximal the magnetic stabilization layer and comprises a first Co-based alloy; and the second magnetic recording layer is in overlying contact with the first magnetic recording layer and comprises a second Co-based alloy.

Preferably, the first Co-based alloy has lower at. % Co than the second Co-based alloy, and the first magnetic recording layer has a lower Hₖ and Mₛ than the second magnetic recording layer, whereby the first magnetic recording layer provides the medium with low transition noise, and the second magnetic recording layer provides the medium with high coercivity and thermal stability.

Further embodiments of the present invention include those wherein the medium further comprises a third magnetic recording layer in overlying contact with the second magnetic recording layer, the third magnetic recording latyer comprising a third Co-based alloy with greater at. % Co than the first Co-based alloy and higher Hₖ and Mₛ for providing the medium with the aforementioned high coercivity and thermal stability.

Still further embodiments of the present invention include those wherein the at least one magnetic recording layer comprises a plurality of magnetic recording layers spaced apart by respective non-magnetic spacer layers; adjacent pairs of the plurality of magnetic recording layers are anti-ferromagnetically coupled (“AFC”) across respective ones of the non-magnetic spacer layers; and each of the non-magnetic spacer layers is less than about 10 Å thick and comprised of Ru or a Ru-based alloy.

Additional advantages, features, and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the various features are not necessarily drawn to scale but rather are drawn as to best illustrate the pertinent features, and in which like reference numerals are employed throughout for designating similar features, wherein:

FIG. 1 schematically illustrates, in simplified, cross-sectional view, a portion of a thin film magnetic recording medium according to an embodiment of the present invention, comprising a single magnetic recording layer;

FIG. 2 schematically illustrates, in simplified, cross-sectional view, a portion of a thin film magnetic recording medium according to another embodiment of the present invention, comprising a pair of magnetic recording layers;

FIG. 3 schematically illustrates, in simplified, cross-sectional view, a portion of a thin film magnetic recording medium according to yet another embodiment of the present invention, comprising three magnetic recording layers; and

FIG. 4 schematically illustrates, in simplified, cross-sectional view, a portion of a thin film magnetic recording medium according to still another embodiment of the present invention, comprising a pair of magnetic recording layers anti-ferromagnetically coupled across a non-magnetic spacer layer.

### DESCRIPTION OF THE INVENTION

The present invention is based upon recognition that improved high a real recording density, thin-film longitudinal magnetic recording media may be fabricated with an at least about 0.5 dB increase in SNR (and with enhancement of other magnetic recording properties) by inclusion of an underlayer comprising manganese (Mn) in a multi-underlayer structure provided beneath the magnetic recording layer(s). According to the invention, the improvements in SNR and other magnetic recording characteristics are advantageously obtained without excessive dilution of the magnetic element, e.g., cobalt (Co) of the magnetic recording layer(s), thereby enabling fabrication of high a real density longitudinal media with low noise as well as high coercivity and thermal stability.

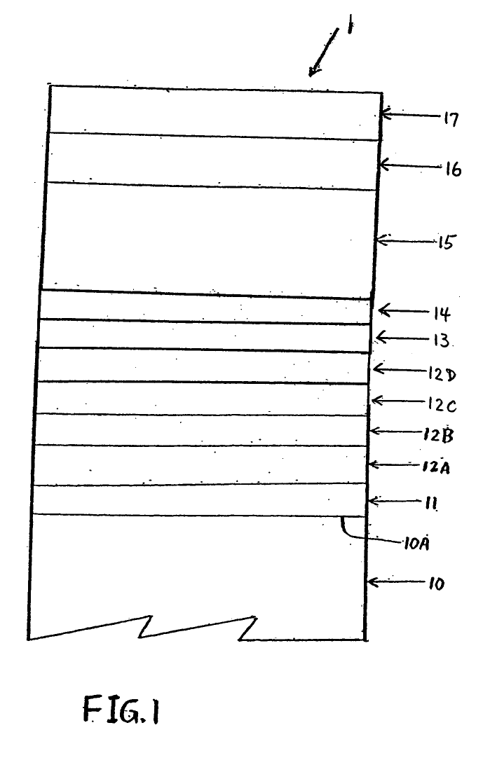

FIG. 1 schematically illustrates, in simplified, cross-sectional view, a portion of a thin film magnetic recording medium 1 according to an embodiment of the present invention. As shown, medium 1 includes a non-magnetic substrate 10 selected from among Al, Al-based alloys such as Al—Mg alloys, NiP-plated Al (“Al/NiP”), other metals and metal alloys, glass, ceramics, polymers, and composites (e.g., glass-ceramics) and laminates of the aforementioned materials. The thickness of substrate 10 is not critical; however, in the case of magnetic recording media for use in hard disk applications, substrate 10 must be of a thickness sufficient to provide the necessary rigidity. Substrate 10 typically comprises Al or an Al-based alloy, e.g., an Al—Mg alloy, or glass or glass-ceramics, and, in the case of Al-based substrates, includes a plating layer, typically of NiP, on the surface 10A (not shown in the figure for simplicity). An optional seed layer 11, typically an about 10 to about 500 Å thick layer of an amorphous or fine-grained material, such as Ni—Al, Fe—Al, Cr—Ti, Cr—Ta, Ta, Ta—W, Ru—Al, and TiN, may be formed over substrate surface 10A or the NiP plating layer.

According to the invention, a stack of thin-film layers comprising a plurality of underlayers overlies substrate 10, including: (1) a first underlayer 12A, typically a chromium (Cr) layer from about 25 to about 40 Å thick, formed in overlying contact with optional seed layer 11 or substrate surface 10A; (2) a second underlayer 12B for refining the grain size of subsequently deposited layers, including the magnetic recording layer(s), formed in overlying contact with the first underlayer 12A, and typically comprised of an about 25 to about 40 Å thick layer of a CrₓMo₁₋ₓB_{y} alloy, where x=about 70 to about 89 and y=about 5 to about 10; and (3) a third underlayer 12C for providing in-plane growth of at least the subsequently deposited magnetic recording layer(s), formed in overlying contact with the second underlayer 12B.

According to the present invention, third underlayer 12C comprises manganese (Mn) in the form of a Mn-containing alloy, illustratively an about 15 to about 22 Å thick layer of a CrMoMn alloy containing about 5 at. % Mn and from about 10 to about 20 at. % Mo.

With continued reference to FIG. 1, the layer stack of medium 1 further includes magnetic stabilization layer 12D formed in overlying contact with third underlayer 12C, and typically comprised of an about 25 to about 32 Å thick layer of a CoₓCr₁₋ₓTa_{y} magnetic alloy, where x=about 74 to about 82 and y=about 3 to about 6; a thin, non-magnetic spacer layer 13 formed in overlying contact with magnetic stabilization layer 12D, typically comprised of an about 7 to about 9 Å thick layer of ruthenium (Ru) or a Ru-based alloy; and a magnetic enhancement layer 14 formed in overlying contact with the non-magnetic spacer layer 13, typically comprised of an about 8 to about 14 Å thick layer of a CoₓCr₁₋ₓB_{y} magnetic alloy, where x=about 74 to about 78 and y=about 2 to about 6. According to the present invention, the magnetic stabilization layer 12D and the magnetic enhancement layer 14 are anti-ferromagnetically (AFC) coupled across the thin, non-magnetic spacer layer 13. Still referring to FIG. 1, medium 1 further includes magnetic recording layer 15, typically an about 100 to about 200 Å thick layer comprised of a Co-based magnetic alloy (e.g., CoCr or a CoCr alloy with at least one additional element selected from the group consisting of: Pt, B, Ta, Nb, Mo, Ru, Si, Ge, Fe, Cu, and Ni; protective overcoat layer 16 formed in overlying contact with magnetic recording layer 15 and typically comprising an about 28 to about 40 Å thick layer of a carbon-containing material, e.g., diamond-like carbon (“DLC”); and a thin lubricant topcoat 17 formed in overlying contact with protective overcoat layer 16 and typically comprising a perfluoropolyether material.

The layer structure of medium 1 may thus be summarized as follows: substrate/seed layer (optional)/1^{st} underlayer/2^{nd} underlayer/3^{rd} underlayer (with Mn)/magnetic stabilization layer/spacer (AFC coupling) layer/magnetic enhancement layer/magnetic recording layer/protective overcoat

According to the invention, each of the layers 11, 12A-12D, and 13-16 of medium 1 may be deposited or otherwise formed by any suitable physical vapor deposition (“PVD”) technique, e.g., sputtering vacuum evaporation, ion plating, cathodic arc deposition (“CAD”), etc., or by a combination of various PVD techniques. Lubricant topcoat layer 17 is typically provided over the upper surface of the protective overcoat layer 16 in conventional fashion, e.g., as by dipping the thus-formed medium into a liquid bath containing a solution of the lubricant compound, followed by removal of excess liquid, e.g., by wiping.

In accordance with embodiments of the present invention, when the non-magnetic substrate 10 comprises a metal or a metal alloy; the first underlayer 12A is Cr; the second underlayer 12B is a CrMoB alloy or a CrB material; the third underlayer 12C is a CrMoMn alloy; and the magnetic stabilization layer 12D is a CoCrTa alloy; whereas, when the non-magnetic substrate 10 comprises a glass or a glass-ceramic material; the first underlayer 12A is a CrTi alloy; the second underlayer 12B is Cr; the third underlayer 12C is a CrMoMn alloy; and the magnetic stabilization layer 12D is a CoCrTa alloy.

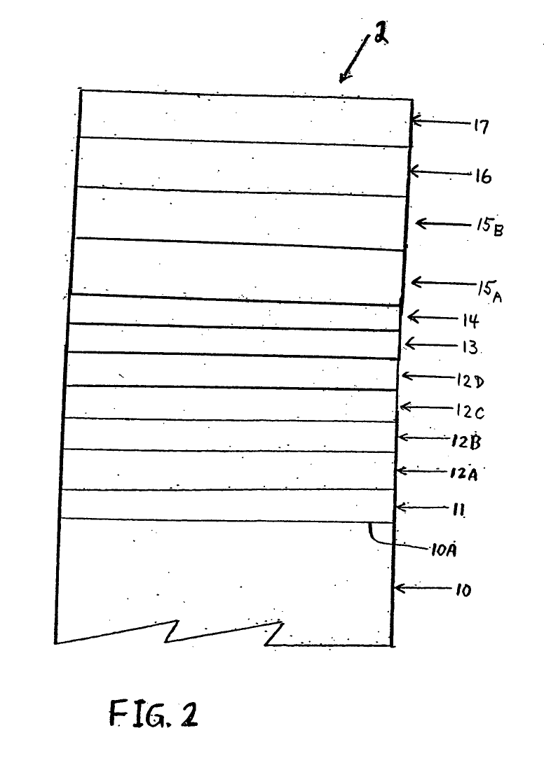

Adverting to FIG. 2, schematically illustrated therein, in simplified, cross-sectional view, is a portion of a thin film magnetic recording medium 2 according to another embodiment of the present invention, similar in essential respect to medium 1 of FIG. 1, but which comprises a pair of magnetic recording layers 15A and 15B.

As illustrated, first magnetic recording layer 15A is formed in overlying contact with magnetic enhancement layer 14 and second magnetic recording layer 15B is formed in overlying contact with first magnetic recording layer 15A. According to a principle of the present invention, the first and second magnetic recording layers 15A and 15B are comprised of respective first and second Co-based alloys, wherein the first Co-based alloy has lower Co content (i.e., is “Co diluted”) than the second Co-based alloy. As a consequence, the first magnetic recording layer 15A has a lower Hₖ and Mₛ than the second magnetic recording layer 15B; the first magnetic recording layer 15A provides medium 2 with low transition noise; and the second magnetic recording layer 15B provides medium 2 with high coercivity and thermal stability.

By way of illustration, but not limitation, the first, lower coercivity magnetic recording layer 15A may be from about 100 to about 120 Å thick and contain about 0.525 at. % Co and the second, higher coercivity magnetic recording layer 15B may be from about 40 to about 60 Å thick and contain about 61 at. % Co.

The layer structure of medium 2 may thus be summarized as follows: substrate/seed layer (optional)/1^{st} underlayer/2^{nd} underlayer/3^{rd} underlayer (with Mn)/magnetic stabilization layer/spacer (AFC coupling) layer/magnetic enhancement layer/1^{st} magnetic recording layer (lower Hₖ and Mₛ)/2^{nd} magnetic recording layer (higher Hₖ and Mₛ)/ protective overcoat

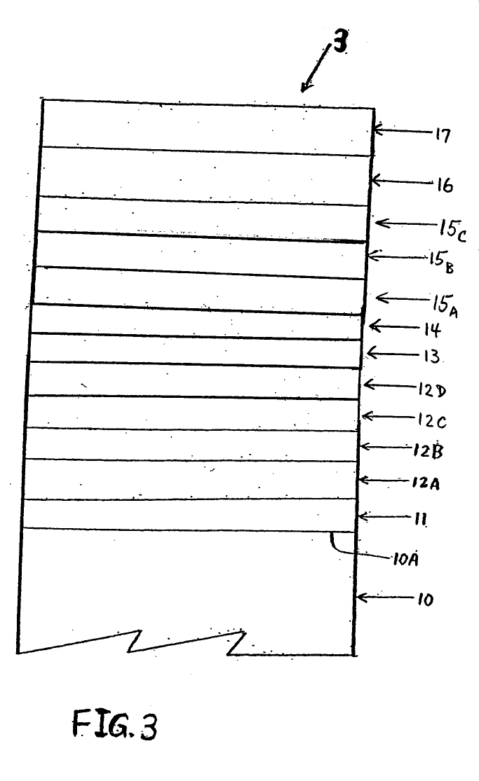

Referring now to FIG. 3, schematically illustrated therein, in simplified, cross-sectional view, is a portion of a thin film magnetic recording medium 3 according to another embodiment of the present invention, similar in essential respect to medium 2 of FIG. 2, but which comprises three magnetic recording layers 15A, 15B, and 15C. As before, first magnetic recording layer 15A is formed in overlying contact with magnetic enhancement layer 14 and second magnetic recording layer 15B is formed in overlying contact with first magnetic recording layer 15A; the first and second magnetic recording layers 15A and 15B are comprised of respective first and second Co-based alloys, wherein the first Co-based alloy has lower Co content (i.e., is “Co diluted”) than the second Co-based alloy. According to this embodiment, third magnetic recording layer 15C is formed in overlying contact with second magnetic recording layer 15B and comprises a third Co-based alloy with greater at. % Co than the first Co-based alloy. As before, the first magnetic recording layer 15A has a lower Hₖ and Mₛ than the second and third magnetic recording layers 15B and 15C; the first magnetic recording layer 15A provides medium 3 with low transition noise; and the second and third magnetic recording layers 15B and 15C provide medium 3 with high coercivity and thermal stability.

By way of illustration, but not limitation, the first, lower coercivity magnetic recording layer 15A may be from about 100 to about 120 Å thick and contain about 52.5 at. % Co, the second, higher coercivity magnetic recording layer 15B may be from about 40 to about 60 Å thick and contain about 61 at. % Co, and the third, higher coercivity magnetic recording layer 15C may be from about 40 to about 60 Å thick and contain about 57 at. % Co.

The layer structure of medium 3 may thus be summarized as follows: substrate/seed layer (optional)/1^{st} underlayer/2^{nd} underlayer/3^{rd} underlayer (with Mn)/magnetic stabilization layer/spacer (AFC coupling) layer/magnetic enhancement layer/1^{st} magnetic recording layer (lower Hₖ and Mₛ)/2^{nd} magnetic recording layer (higher Hₖ and Mₛ)/3^{rd} magnetic recording layer (higher Hₖ and Mₛ)/protective overcoat

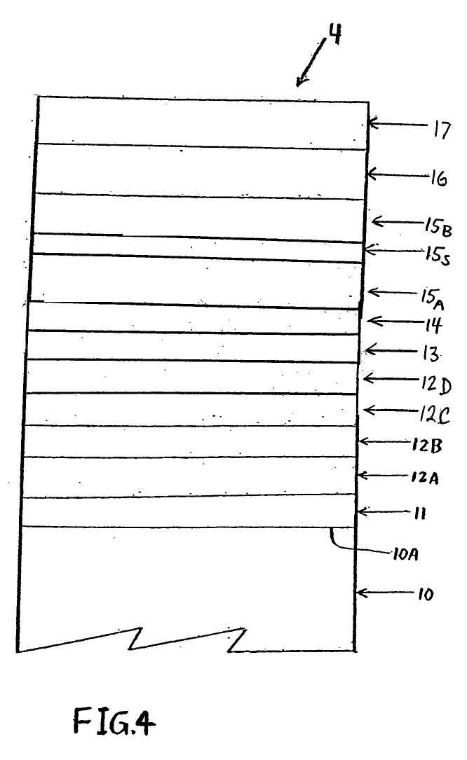

Referring to FIG. 4, schematically illustrated therein, in simplified, cross-sectional view, is a portion of a thin film magnetic recording medium 4 according to still another embodiment of the present invention, similar in essential respect to medium 2 of FIG. 2, but which comprises a pair of magnetic recording layers 15_{A} and 15_{B} which are anti-ferromagnetically coupled (“AFC”) across thin, non-magnetic spacer layer 15_{S}. According to this embodiment, each of the magnetic recording layers 15_{A} and 15_{B} may be similar to magnetic recording layers 15A and 15B of the previous embodiments and comprised of the aforementioned Co-based magnetic alloys. Thin, non-magnetic spacer layer 15_{S} is typically less than about 10 Å thick and comprised of Ru or a Ru-based alloy. Finally, whereas only one pair of anti-ferromagnetically coupled magnetic recording layers are specifically illustrated in the embodiment of FIG. 4, the present invention contemplates formation and use of media with additional pairs of anti-ferromagnetically coupled magnetic recording layers.

The layer structure of medium 4 may thus be summarized as follows: substrate/seed layer (optional)1^{st} underlayer/2^{nd} underlayer/3^{rd} underlayer (with Mn)/magnetic stabilization layer/spacer (AFC coupling) layer/magnetic enhancement layer/1^{st} magnetic recording layer (lower Hₖ and Mₛ)/spacer (AFC coupling) layer/2^{nd} magnetic recording layer (higher Hₖ and Mₛ)/protective overcoat

The efficacy of the inventive methodology will now be demonstrated with reference to the following examples, wherein the following notations are employed for designating magnetic performance characteristics of media fabricated according to the principles of the present invention:

PW50:pulse width at 50% amplitude

OW:overwrite

PE-EFL:position error rate @ error rate floor

OTC-EFL:off-track capability @0 error rate floor

AmEsnr:media equalized signal-to-noise ratio

Elec Esnr:electronics equalized signal-to-noise ratio

Total Esnr:total equalized signal-to-noise ratio

MWW:magnetic write width

WPE:write width+track encroachment

### EXAMPLE 1

The following medium according to the invention with 2 magnetic recording layers was fabricated on a 95mm×69 mil Al substrate with an Intevac 250B sputtering apparatus:
Substrate/Cr/Cr_{0.78}Mo_{0.15}B_{0.07}/Cr_{0.75}Mo_{0.20}Mn_{0.05}/Co_{0.82}Cr_{0.14}Ta_{0.04}/Ru/Co_{0.78}Cr_{0.18}B_{0.04}/Co_{0.525}Cr_{0.26}Pt_{0.135}B_{0.06}Cu_{0.02}/Co_{0.61}Cr_{0.15}Pt_{0.12}B_{0.12}/carbon

A similar medium was fabricated with the Cr_{0.75}Mo_{0.20}B_{0.05} third underlayer replaced by a Cr_{0.87}Mo_{0.10}Ta_{0.03} third underlayer. Results of measurement of the above listed magnetic performance characteristics are presented in Table I below:

TABLE I

| Disk | PW50 | OW | PE- | OTC- | Am | Elec | Total | MWW | WPE |
|---|---|---|---|---|---|---|---|---|---|
| Description | (μin.) | (dB) | EFL | EFL | Esnr | Esnr | Esnr | (μin.) | (μin.) |
| Cr_{.87}Mo_{.10}Ta_{.03} | 2.93 | 33.59 | −5.32 | −4.60 | 14.65 | 16.95 | 12.64 | 6.81 | 6.77 |
| Cr_{.75}Mo_{.20}B_{.05} | 2.93 | 34.27 | −5.75 | −4.96 | 15.12 | 17.20 | 13.03 | 7.00 | 7.07 |

As is evident from Table I, the medium fabricated according to the invention, wherein the third underlayer was Cr_{0.75}Mo_{0.20}B_{0.05}, exhibited an increase in SNR of 0.47, an increase in OTC-EFL of 0.36, and an increase in PE-EFL of 0.43, relative to the medium fabricated with a Cr_{0.87}Mo_{0.10}Ta_{0.03} third underlayer.

### Example 2

The following medium according to the invention with 3 magnetic recording layers was fabricated with an Intevac 200L sputtering apparatus:
Substrate/Cr/Cr_{0.96}B_{0.04}/Cr_{0.75}Mo_{0.20}Mn_{0.05}/Co_{0.82}Cr_{0.14}Ta_{0.04}/Ru/Co_{0.78}Cr_{0.18}B_{0.04}/Co_{0.525}Cr_{0.26}Pt_{0.135}B_{0.06}Cu_{0.02}/Co_{0.61}Cr_{0.15}Pt_{0.12}B_{0.12}/Co_{0.57}Cr_{0.13}Pt_{0.14}B_{0.14}Cu_{0.02}/carbon

A similar medium was fabricated with the Cr_{0.75}Mo_{0.20}B_{0.05} third underlayer replaced by a Cr_{0.87}Mo_{0.10}Ta_{0.03} third underlayer. Results of measurement of the above listed magnetic performance characteristics are presented in Table II below:

TABLE II

| Disk | PW50 | OW | PE- | OTC- | Am | Elec | Total | MWW | WPE |
|---|---|---|---|---|---|---|---|---|---|
| Description | (μin.) | (dB) | EFL | EFL | Esnr | Esnr | Esnr | (μin.) | (μin.) |
| Cr_{.87}Mo_{.10}Ta_{.03} | 2.89 | 33.98 | −4.86 | −4.75 | 14.74 | 19.20 | 13.52 | 6.16 | 6.66 |
| Cr_{.75}Mo_{.20}B_{.05} | 2.87 | 35.13 | −5.07 | −5.01 | 15.09 | 19.24 | 13.68 | 6.51 | 6.68 |

As is evident from Table II, the medium fabricated according to the invention, wherein the third underlayer was Cr_{0.75}Mo_{0.20}B_{0.05}, exhibited an increase in SNR of 0.35, an increase in OTC-EFL of 0.26, and an increase in PE-EFL of 0.21, relative to the medium fabricated with a Cr_{0.87}Mo_{0.10}Ta_{0.03} third underlayer.

In addition, comparison of the X-ray diffraction rocking curves of the Co (11.0) peaks of the two media fabricated in Example 1 (i.e., with Cr_{0.75}Mo_{0.20}B_{0.05} and Cr_{0.87}Mo_{0.10}Ta_{0.03} underlayers) indicated that the Co (11.0) peak is enhanced when the Ta is replaced with Mn, implying that Co in-plane growth is enhanced according to the inventive methodology.

The present invention thus advantageously provides high quality, thermally stable, high a real recording density longitudinal magnetic recording media with increased SNR as well as enhancement of other pertinent magnetic recording characteristics. Moreover, the inventive methodology can be practiced in a cost-effective manner, utilizing conventional manufacturing technology and equipment (e.g., sputtering technology and equipment) for automated, large-scale manufacture of magnetic recording media, such as hard disks. Finally, the invention is not limited to use with hard disks, but rather is broadly applicable to the formation of thermally stable, high SNR, high a real density magnetic recording media suitable for use in all manner of devices, products, and applications.

In the previous description, numerous specific details are set forth, such as specific materials, structures, processes, etc., in order to provide a better understanding of the present invention. However, the present invention, can be practiced without resorting to the details specifically set forth herein. In other instances, well-known processing techniques and structures have not been described in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

What is claimed is:

1. A thin film magnetic recording medium with enhanced signal-to-noise ratio (SNR), comprising:
a non-magnetic substrate having a surface; and
a layer stack atop said substrate surface, said layer stack comprising at least one longitudinal magnetic recording layer and a plurality of layers beneath said at least one magnetic recording layer, said plurality of layers including:
i. a first underlayer proximal said substrate surface;
ii. a second, grain size refinement underlayer in overlying contact with said first underlayer;
iii. a third, in-plane growth orientation underlayer in overlying contact with said second underlayer; and
iv. a magnetic stabilization layer in overlying contact with said third underlayer, wherein:
said third underlayer comprises manganese (Mn).

2. The medium as in claim 1, wherein:
said third underlayer comprises a CrMoMn alloy.

3. The medium as in claim 2, wherein:
said CrMoMn alloy contains about 5 at. % Mn.

4. The medium as in claim 3, wherein:
said CrCoMn alloy contains from about 10 to about 20 at. % Mo.

5. The medium as in claim 4, wherein:
said third underlayer is from about 15 to about 22 Å thick.

6. The medium as in claim 1, wherein:
said non-magnetic substrate comprises a metal or a metal alloy;
said first underlayer is Cr;
said second underlayer is a CrMoB alloy or a CrB material;
said third underlayer is a CrMoMn alloy; and
said magnetic stabilization layer is a CoCrTa magnetic alloy.

7. The medium as in claim 1, wherein:
said non-magnetic substrate comprises a glass or a glass-ceramic material;
said first underlayer is a CrTi alloy;
said second underlayer is Cr;
said third underlayer is a CrMoMn alloy; and
said magnetic stabilization layer is a CoCrTa magnetic alloy.

8. The medium as in claim 1, wherein:
said plurality of layers further includes a non-magnetic spacer layer in overlying contact with said magnetic stabilization layer and a magnetic enhancement layer in overlying contact with said spacer layer, wherein said magnetic stabilization and enhancement layers are anti-ferromagnetically coupled (AFC) across said spacer layer.

9. The medium as in claim 8, wherein:
said non-magnetic spacer layer comprises a material selected from the group consisting of ruthenium (Ru) and Ru-based alloys.

10. The medium as in claim 8, wherein:
said magnetic stabilization layer comprises a Co-based magnetic alloy.

11. The medium as in claim 8, wherein:
said magnetic enhancement layer comprises a Co-based magnetic alloy.

12. The medium as in claim 1, wherein:
said at least one magnetic recording layer comprises a plurality of magnetic layers in overlying contact.

13. The medium as in claim 12, comprising:
first and second magnetic recording layers.

14. The medium as in claim 13, wherein:
said first magnetic recording layer is proximal said magnetic stabilization layer and comprises a first Co-based magnetic alloy; and
said second magnetic recording layer is in overlying contact with said first magnetic recording layer and comprises a second Co-based magnetic alloy.

15. The medium as in claim 14, wherein:
said first Co-based alloy has lower at. % Co than said second Co-based alloy.

16. The medium as in claim 15, wherein:
said first magnetic recording layer has a lower Hₖ and Mₛ than said second magnetic recording layer, whereby said first magnetic recording layer provides said medium with low transition noise, and said second magnetic recording layer provides said medium with high coercivity and thermal stability.

17. The medium as in claim 16, wherein:
said medium further comprises a third magnetic recording layer in overlying contact with said second magnetic recording layer, said third magnetic recording layer comprising a third Co-based alloy with higher at. % Co than said first Co-based alloy and higher Hₖ and Mₛ for providing said medium with said high coercivity and thermal stability.

18. The medium as in claim 1, wherein:
said at least one magnetic recording layer comprises a plurality of magnetic recording layers spaced apart by respective non-magnetic spacer layers.

19. The medium as in claim 18, wherein:
adjacent pairs of said plurality of magnetic recording layers are anti-ferromagnetically coupled (“AFC”) across respective ones of said non-magnetic spacer layers.

20. The medium as in claim 19, wherein:
each of said non-magnetic spacer layers is less than about 10 Å thick and comprised of Ru or a Ru-based alloy.
